(19) United States
(12) Patent Application Publication
(10) Pub. No.: US 2015/0222975 A1
(43) Pub. Date: Aug. 6, 2015

(54) Combination Audio and Light System

(71) Applicant: Yao Hung Huang, Rende Township (TW)

(72) Inventor: Yao Hung Huang, Rende Township (TW)

(21) Appl. No.: 14/173,456

(22) Filed: Feb. 5, 2014

(51) Int. Cl. H04R 1/02; F21S 10/00; F21S 9/02; F21S 4/00; F21V 23/04; F21V 33/00; F21V 7/04

(52) U.S. Cl. CPC H04R 1/028; F21V 33/0056; F21S 10/00; F21V 7/04; F21S 4/008; F21V 23/04; F21S 9/02; H04R 2499/10; F21Y 2101/02

(57) ABSTRACT

A combination audio and light system consisting of an electronic circuit comprising a power supply, a switch, an audio circuit and at least one light source. The power supply has an input connected to a power source and an output. The switch is a normally open single-pole double-throw (SPDT) switch that has a first contact and a second contact. The switch's pole is connected to the output of the power supply. The audio circuit processes and amplifies an amplified or non-amplified audio signal, and has an input connected to the first contact on the switch, and an output connected to the loudspeaker. The light source is connected to the second contact on the switch. An enclosure is dimensioned to enclose the electronic circuit, and has at least one loudspeaker opening for the loudspeaker and at least one light source opening for the light source.

### TECHNICAL FIELD

The invention generally pertains to audio and light devices, and more particularly to a combination audio and light system.

### BACKGROUND ART

The pairing of audio with lights has long been an effective means of providing combined auditory and visual stimulation. Musicians and other performers rely on lights to augment the music that is being played. Most audience members now expect to see a compelling display of lights along with the music that is being performed. Lights have also become an important element at discos, where people dance to the combined music and lights.

Unfortunately, audio and light combinations are usually only experienced at venues such as performance spaces or discos. What is needed is a single device or system that provides a combination of audio and lights. There have been attempts to produce light boxes that provide lights to accompany music, but these boxes have to be connected to a stereo or other audio output. An all-in-one device or system, would be a significant improvement. A single system that provides both audio and lights would be easy to use and would satisfy an onlookers desire to experience audio and lights simultaneously. By synchronizing the lights with the audio, a convenient, easy-to-transport audio and light system could be utilized anywhere to provide the experience of being at a music concert or a disco.

### DISCLOSURE OF THE INVENTION

In its basic design, the combination audio and light system consists of an electronic circuit comprising a power supply having an input connected to a power source and an output connected to the pole of a single-pole four-contact switch. The first switch contact is connected to OFF, and the second switch contact Is connected to the input of an audio circuit having means for receiving and processing an amplified or non-amplified audio signal. The output of the audio circuit is connected to at least one loudspeaker. The third switch contact is connected to at least one light source, and the fourth switch contact is connected to both, the audio circuit and the light source. An enclosure is dimensioned to enclose the electronic circuit and has at least one loudspeaker opening that is dimensioned to allow the at least one loudspeaker to be attached thereto. At least one light source opening is dimensioned to allow the at least one light source to be attached thereto. The light source is selected from the group consisting of light emitting diodes (LEDs), incandescent bulb(s) or neon light(s).

In view of the above disclosure, the primary object of the invention is to provide a combination audio and light system that allows an individual or multiple persons to enjoy audio and visual stimuli from a single device.

In addition to the primary object of the invention, it is also an object of the invention to provide a combination audio and light system that:
is easy to use,
can be powered by a utility power source, batteries or a USB connection,
can be used indoors or outdoors,
can be easily transported from one location to another,
can be made in various sizes,
can be used as a primary audio and/or light source at a public event, or can augment an existing audio and light system,
can be used individually or in groups of multiple systems,
is economical since it provides both audio and lights,
can be made of a strong durable material such as metal, or can be made of a light-weight material such as plastic, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram of the combination audio and light system (CALS).

FIG. 2 is a block diagram of a basic design of the CALS.

FIG. 3 is a block diagram of an advanced design of the CALS.

FIG. 4 is an elevational front view of a light source configured as an LED cluster.

FIG. 5 is a schematic diagram of an LED cluster that is comprised of a plurality of white LEDs.

FIG. 6 is a schematic diagram of an LED cluster that is comprised of a plurality of white LEDs and a like plurality of red LEDs.

FIG. 7 is a schematic diagram of an LED cluster that is comprised of a plurality of white LEDs and a like plurality of yellow LEDs.

FIG. 8 is an orthographic front view of an enclosure having a loudspeaker attached to the front surface and an LED cluster attached to the first side surface.

FIG. 9 is an orthographic front view of an enclosure having on the front surface in a linear sequence a loudspeaker, an LED cluster, a loudspeaker and an LED cluster.

FIG. 10 is an orthographic front view of an enclosure having a front surface that is divided into an upper section having a loudspeaker and an LED cluster, and a lower section having an LED cluster and a loudspeaker. This figure also shows an enclosure overhead attachment panel.

FIG. 11 is an elevational front view of an enclosure having an LED cluster attached to each end of the front surface and with an amplifier attached between the two LED clusters. This figure also shows an enclosure stand.

FIG. 12 is an orthographic front view of a circular enclosure having an LED cluster attached to a first end and a loudspeaker attached to a second end.

### BEST MODE FOR CARRYING OUT THE INVENTION

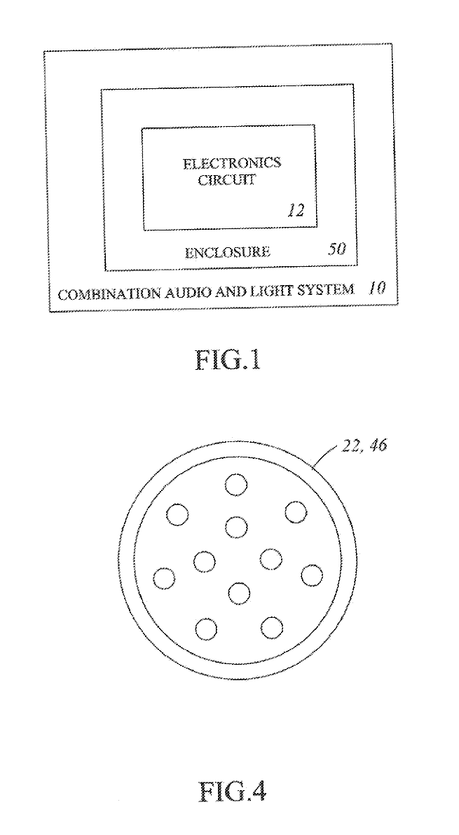

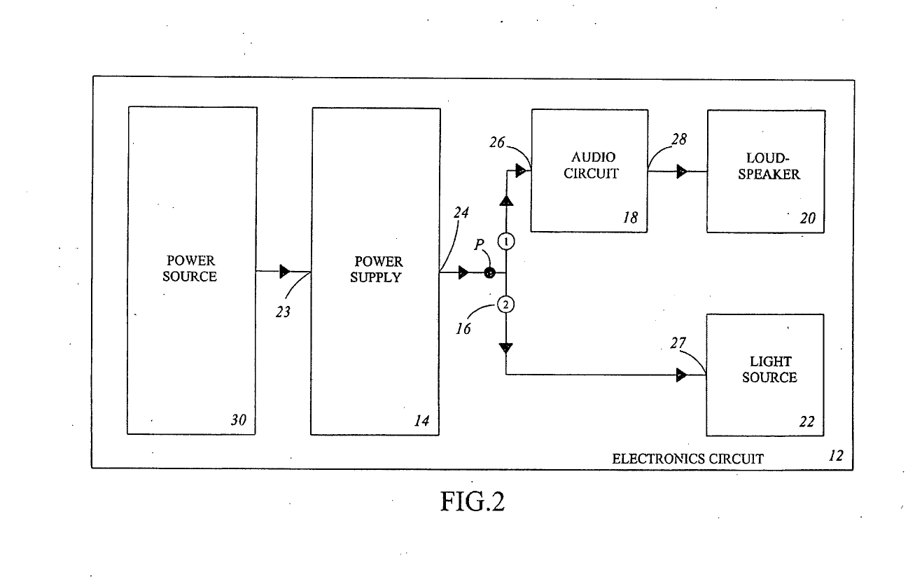

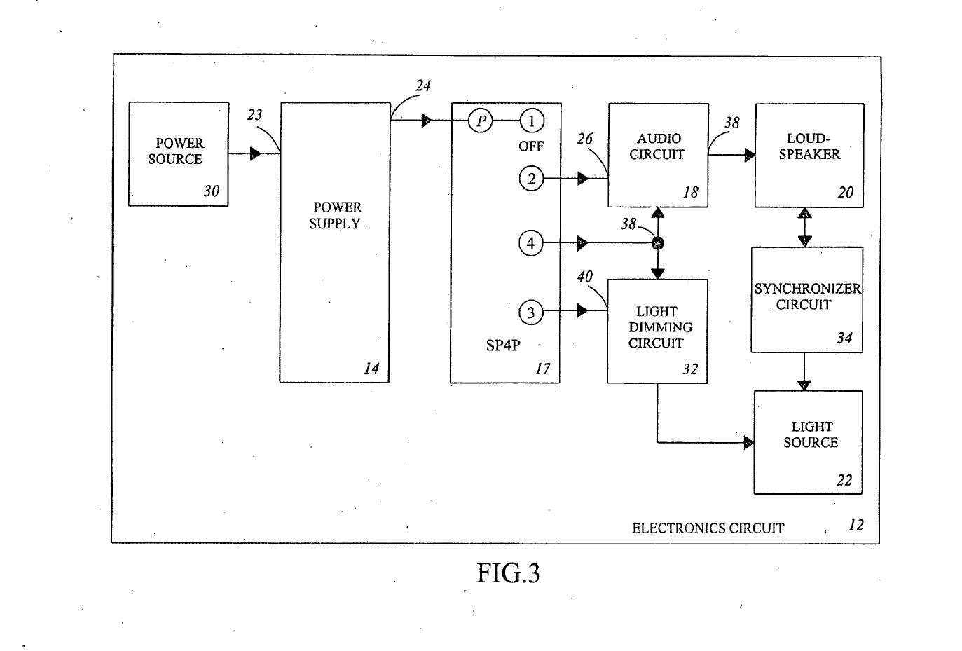

The best mode for carrying out the invention is presented in terms that disclose a preferred embodiment of a combination audio and light system (CALS). The overall preferred embodiment of the CALS 10, is shown in FIG. 1 and is further presented in two design configurations: a basic design, as shown in FIG. 2 and in an advanced design as shown in FIG. 3. Both designs are comprised of two major elements: an electronics circuit 12 and an enclosure 50.

The basic design of the electronics circuit 12, as shown in FIG. 2, is comprised of a power supply 14, a normally-open single-pole double-throw switch (SPDT) 16, an audio circuit 18, at least one loudspeaker 20 and a light source 22. The power supply 14 has an input 23 that is connected to a power source 30 and an output 24 that is connected to the pole (P) of the SPDT switch 16. The power source 30 is selected from the group consisting of a utility power source, an internal battery, an external battery or a USB connection. The first contact of the switch 16 is applied to the input 26 of audio circuit 18 which has an output 28 applied to the at least one loudspeaker 20. The second contact of the switch 16 is applied to the input 27 of the light source 22, as shown in FIG. 2. The audio circuit 18 has means for processing an amplified or non-amplified audio signal supplied from an external source.

The advanced design of the electronics circuit 12, as shown in FIG. 3, is comprised of a power supply 14, a single-pole, four position (SP4P) switch 17, an audio circuit 18, at least one loudspeaker 20, a light source 22, an internal or external light source dimming circuit 32 and an audio/light source synchronizing circuit 34. The audio circuit 18 has means for receiving and processing an amplified audio signal (i.e. audio amplifier) or a non-amplified audio signal (i.e. guitar input). The power supply 14 has an input 23 that is applied from the power source 30 and an output 24 that is connected to the pole (P) of the SP4P switch 17. The first position places the SP4P switch 17 in a circuit OFF condition. The second switch position is connected to the input 26 of the audio circuit 18 which has an output 38 that is applied to the at least one loudspeaker 20. The audio circuit 18 receives and processes the audio signal that is applied from the external audio source. The third switch position is connected via the input 40 to the light source 22 via a light source dimming circuit 32; the fourth position is connected to a junction input 39 which applies power from the power supply 14 to both the audio circuit 18 and to the light source 22. As shown in FIG. 3, the power to the light source 22 is applied via the light source dimming circuit 32 which can be an integral element of the light source or can consist of an external circuit. The audio/light source synchronizing circuit 34, as shown in FIG. 3, allows the tempo of the audio signal to control the ON-OFF duty cycle at the light source 22 which is applied power through the input 42.

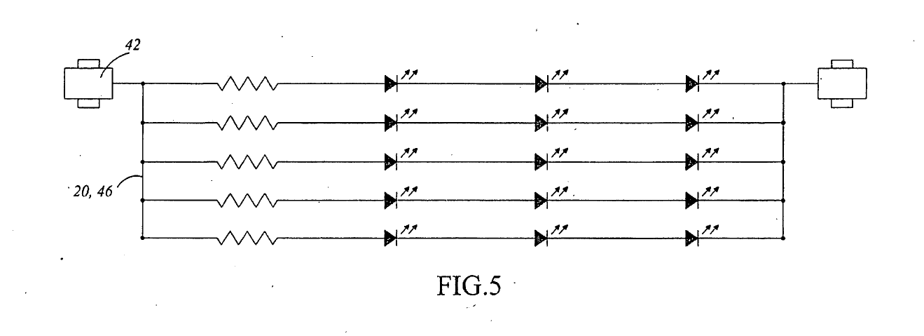

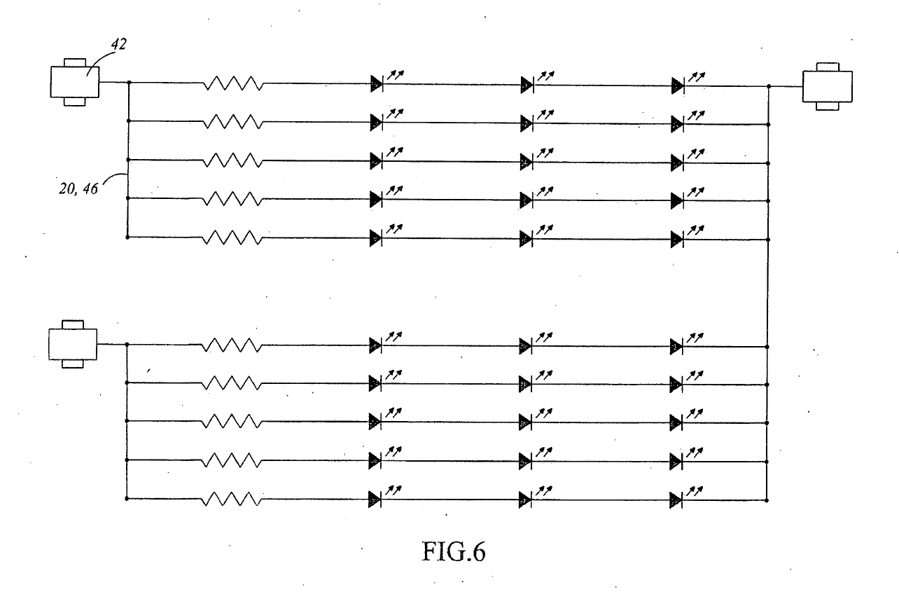

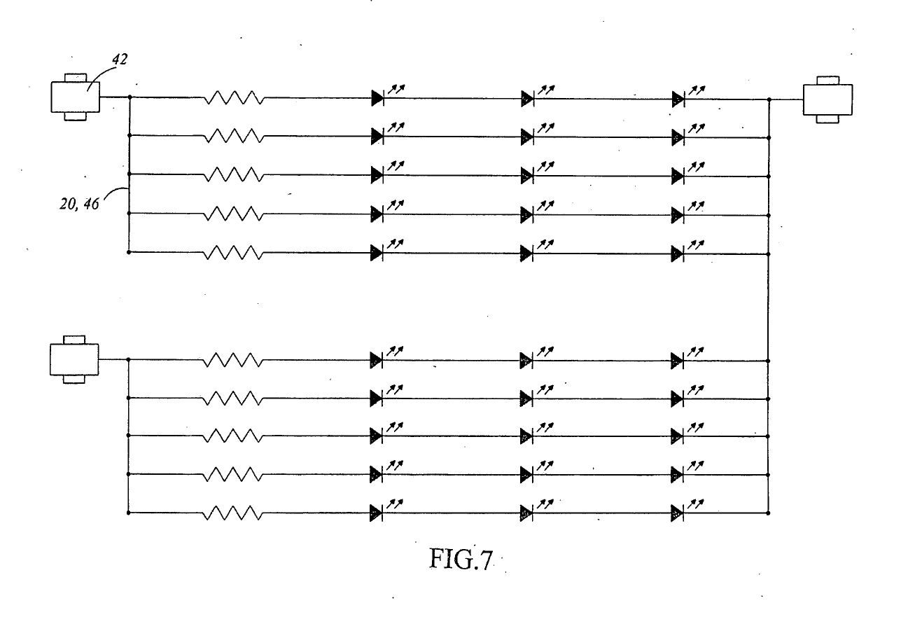

The light source 22 is selected from the group consisting of light emitting diodes (LEDs), incandescent bulbs and neon lights. The LEDs are preferably comprised of an LED cluster 46, as shown in FIG. 4 and schematically in FIGS. 5, 6 and 7. As shown in FIGS. 5, 6 and 7, the LEDs are connected in a series-parallel configuration through input 42 of the light source 44 (LED cluster 46). In FIG. 5, the LED cluster 46 is comprised of a plurality of white LEDs. In FIG. 6, the LED cluster 46 is comprised of a plurality of white LEDs and a like plurality of red LEDs. In FIG. 7, the LED cluster 46 is comprised of a plurality of white LEDs and a like plurality of yellow LEDs. The above LED clusters are given as examples, as other quantities and combinations of colored LEDs can also be utilized. Additionally, a circuit can be included that will randomly turn the lights ON and OFF, or will cause the lights to rapidly turn ON and OFF for a strobe effect.

The enclosure 50, as shown in FIGS. 8-12, is dimensioned to enclose the electronics circuit 12, as shown in FIGS. 2 and 3. The enclosure 50 is disclosed in five designs, as shown in FIG. 8. The basic design has at least one loudspeaker opening 64 that is dimensioned to attach the at least one loudspeaker 20 and further having at least one light source opening 66 dimensioned to attach the at least one light source 22. Depending on the desire and/or requirements of a user of the CALS 10, the enclosure 50 can he dimensioned to accept a small or large diameter loudspeaker. A larger diameter loudspeaker will provide a more substantial bass response from the outputted audio.

The first enclosure 50, as shown in FIG. 8, has a cubic shape having a front surface 52, a rear surface 54, an upper surface 56, a lower surface 58, a first side surface 60 and a second side surface 62. The front surface 52 has at least one loudspeaker opening 64 that is dimensioned to accept and attach the at least one loudspeaker 20. The first side surface 60 has at least one light source opening 66 that is dimensioned to accept and attach the at least one light source 22.

The second enclosure 50, as shown in FIG. 9, has an elongated square shape having a front surface 52 to which is attached in a linear sequence a first loudspeaker 20, an LED cluster 46, a second loudspeaker 20 and a second LED cluster 46.

The third enclosure 50, as shown in FIG. 10, has a substantially square shape having a front surface 52 that is divided into an upper section 76 and a lower section 78. The upper section 76 has attached a first loudspeaker 20 and a first LED cluster 46. The lower section 78 has in a vertical alignment a second LED cluster 46 and a second loudspeaker 20.

The fourth enclosure 50, as shown in FIG. 11 has a front surface 52 having in horizontal alignment a first LED cluster 46, a second LED cluster 46 and a loudspeaker 20 located between the first and second LED clusters 46.

The fifth enclosure 50, as shown in FIG. 12, has an elongated circular shape 82 having a first end 84 and a second end 86. To the first end 84 Is attached an LED cluster 46 and to the second end 86 is attached a loudspeaker 20.

To allow the enclosure 50 to he attached to an overhead structure, an overhead panel 88 is attached to the upper surface 56 of the enclosure 50, as shown in FIG. 10. Likewise, as shown in FIG. 11, a stand 84 is attached to the lower surface 58 of the enclosure 50. Both the overhead panel 88 and the stand 84 have means 90 for allowing the panel 88 or stand 84 to be vertically adjusted.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A combination audio and light system (CALS) comprising:
a) an electronic circuit comprising:
(1) a power supply having an input connected to a power source, and an output,
(2) a normally open single-pole double-throw (SPDT) switch having a first contact and a second contact, wherein the pole is connected to the output of said power supply,
(3) an audio circuit having means for processing an amplified or non-amplified audio signal said audio circuit having an input connected to the first contact on said SPDT switch and an output connected to at least one loudspeaker,
(4) at least one light source connected to the second contact on said switch, and
b) an enclosure dimensioned to enclose said electronic circuit, said enclosure having at least one loudspeaker opening dimensioned to attach said at least one loudspeaker and having at least one light source opening dimensioned to attach said at least one light source.

2. A combination audio and light system (CALS) comprising:
a) an electronic circuit comprising a power supply having an input connected to a power source and an output connected to the pole of a single-pole four-contact (SP4C) switch, wherein the first switch contact is connected to SYSTEM OFF, the second switch contact is connected to the input of an audio circuit having means for receiving and processing an amplified or non-amplified audio signal, wherein the output of the audio circuit is connected to at least one loudspeaker, wherein the third switch contact is connected to at least one light source and the fourth switch contact is connected to both the audio circuit and the light source, and
b) an enclosure dimensioned to enclose said electronic circuit, said enclosure having at least one loudspeaker opening that is dimensioned to allow said at least one loudspeaker to be attached thereto, and at least one light source opening that is dimensioned to allow said at least one light source to be attached thereto.

3. The CALS as specified in claim 2 wherein said power source is selected from the group consisting of a utility power source, an internal battery, an external battery and a USB connection.

4. The CALS as specified in claim 2 wherein said light source is selected from the group consisting of light emitting diodes (LEDs), incandescent bulbs and neon lights

5. The CALS as specified in claim 4 wherein said LEDs are further comprised of aa LED cluster.

6. The CALS as specified in claim 5 wherein said LED cluster is further comprised of a plurality of white LEDs connected in a series parallel configuration.

7. The CALS as specified in claim 5 wherein said LED cluster is further comprised of a plurality of white LEDs and a like plurality of red LEDs connect in a series parallel configuration.

8. The CALS as specified in claim 5 wherein said LED cluster is further comprised of a plurality of white LEDs and a like plurality of yellow LEDs connected in a series parallel configuration.

9. The CALS us specified in claim 4 former comprising an LED/loudspeaker synchronizing circuit that is connected to said at least one loudspeaker and said at least one LED cluster, wherein said synchronizing circuit allows the tempo of the audio signal to control the ON-OFF cycle of said light source.

10. The CALS as specified in claim 2 further comprising a light source dimming circuit connected between the third switch contact and the at least one light source.

11. The CALS as specified in claim 2 wherein said enclosure has a front surface, a rear surface, an upper surface, a lower surface, a first side surface and a second side surface.

12. The CALS as specified in claim 2 wherein the front surface of said enclosure has attached in a linear sequence a first loudspeaker, a first LED cluster, a second loudspeaker and a second LED cluster.

13. The CALS as specified in claim 2 wherein the front surface of said enclosure includes an upper section having a first loudspeaker and a first LED cluster, and a lower section having In a vertical alignment a second LED cluster and a second loudspeaker.

14. The CALS as specified in claim 2 wherein said enclosure has an elongated circular shape with a first end to which is attached an LED cluster and a second end to which is attached a loudspeaker.

15. The CALS as specified in claim 2 wherein the at least one loudspeaker opening further comprises a speaker grid cloth attached around the area encompassing the perimeter of the speaker opening.

16. The CALS as specified in claim 11 further comprising a reflective ring that is located around the perimeter of the at least one LED cluster opening.

17. The CALS as specified in claim 2 wherein tire front surface of said enclosure has in a horizontal alignment a first LED cluster, a second LED cluster and a loudspeaker located between the first and second LED clusters.

18. The CALS as specified in claim 2 wherein the lower surface of said enclosure further comprises an enclosure stand.

19. The CALS as specified in claim 17 wherein said enclosure stand having means for being vertically adjusted.

20. The CALS as specified in claim 2 wherein the upper surface of said enclosure further comprises an overhead panel having means for allowing said enclosure to be attached to an overhead structure.
